(19) United States
(12) Patent Application Publication
(10) Pub. No.: US 2009/0282248 A1
(43) Pub. Date: Nov. 12, 2009

(54) METHOD AND SYSTEM FOR SECURING ELECTRONIC MAIL

(75) Inventor: Eric W B Dias, Bangalore (IN)

Correspondence Address: IBM Corporation (Endicott);c/o Ortiz & Lopez, P.O. Box 4484, Albuquerque, NM, 87196-4484, US

(73) Assignee: International Business Machines Corporation.

(21) Appl. No.: 12/118,513

(22) Filed: May 9, 2008

(51) Int. Cl. H04L 9/00

(52) U.S. Cl. 713/170

(57) ABSTRACT

A system and method for securing electronic mail by providing secure access to e-mail folders. A number of folders can be created in order to classify electronic mail content. Folders can be encrypted and locked utilizing a password. A “closed lock” symbol can be displayed by the side of a folder when the folder is locked and an “open lock” symbol can be displayed when the folder is opened, thereby providing a visual indication of the status of the folder. The folders can also be automatically locked after a period of time, which can be defined by a user or the e-mail system. The electronic mail content in the locked folders cannot be displayed when a user elects to display the contents of all folders, thereby providing an additional level of security. Similarly, restricted access can also be provided to a user or a group of users to access the locked folder(s).

### TECHNICAL FIELD

Embodiments are generally related to data-processing systems and methods. Embodiments also relate in general to the field of computers and similar technologies, and in particular to software utilized in this field. Embodiments are further related to electronic mail systems.

### BACKGROUND OF THE INVENTION

Electronic Mail (e-mail) provides a means for sending electronic messages from one computer user to another. Electronic mail is a store and forward method of composing, sending, storing, and receiving messages over electronic communication systems. The term “e-mail” can be applied both to Internet e-mail based on Simple Mail Transfer Protocol (SMTP) and to an Intranet system, which allow users within one organization to e-mail each other. Workgroup collaboration organizations often utilize Internet protocols for internal e-mail service. E-mail also delivers bulk-unwanted messages, or “spam” messages which can be automatically deleted by filter programs.

An e-mail client can be a front-end computer program utilized to manage e-mail. In a typical enterprise environment, a mail server possesses a local mail delivery agent or client that stores an incoming e-mail on a local file system and delivers it to an end user via a Post Office Protocol (POP) or an Internet Message Access Protocol (IMAP). Such agents typically provide the basic functionality of logging in e-mail message and copying the message to a client message. E-mail clients such as, for example, Mozilla Thunderbird and Microsoft Outlook can perform a combined operation of a mail transfer agent (MTA), a mail delivery agent (MDA), a mail retrieval agent (MRA) and a mail user agent (MUA). Simple MUAs, however, are also sometimes referred to as e-mail clients. The MUA functions by connecting to a mailbox into which e-mail has been fetched and stored in a particular format. The MUA typically presents a simple user interface to perform tasks with the e-mail. MUA, however, is incapable of sending or retrieving mail.

In a POPS mail setup, the MRA retrieves mail from a remote mail server and the MDA delivers the retrieved mail to a local mailbox. Finally, the MUA can be utilized to connect with the local mailbox. The MTA is then “called” in order to connect a remote MTA for the sending of e-mail. Some of the components, however, may be integrated into the same application. For example, in many MUAs, at least a basic MTA is built into the MUA. In an IMAP mail setup, the MDA is unnecessary as the mail remains on the mail server and is directly read from there.

The SMTP protocol can be utilized to send e-mail, whereas POP3 and the IMAP implementations receive e-mail. Another important standard supported by most e-mail clients is Multipurpose Internet Mail Extensions (MIME), which is capable of sending binary file e-mail attachments. Attachments are files that are not part of the e-mail proper, but are sent with the e-mail. Most e-mail clients utilize an X-Mailer header to identify the software utilized to send the message. However, according to the RFC 2076 standard, the X-Mailer header is a common non-standard header. For example, a Thunderbird extension referred to as dispMUA, supports over 500 headers and recognizes almost 2000 others headers.

In addition to “fat” client e-mail clients and small MUAs in cooperation with a local MDA/MTA/MRA, there are also Web-based e-mail programs referred to simply as “webmail”. Webmail possesses several advantages, which include the ability to send and receive e-mail from anywhere utilizing a single application such as a web browser. This eliminates the need to setup the MTA/MRA/MDA/MUA chain. Examples of e-mail services which also provide the user with a web mail interface are Hotmail, Gmail, etc.

In the majority of prior art e-mail client systems, a user is typically required to authenticate and login to access e-mails. Such e-mail approaches do not provide secure access to confidential or user selected mails. FIG. 4, for example, illustrates a graphical user interface window 350 associated with a prior art e-mail client system, in which a user is allowed to create a number of folders as required to classify the mail content. Such an e-mail client system provides access to all user e-mails whenever a user is logged into the e-mail client system. Therefore, access security is not provided to confidential e-mail messages that a user may not want others to view, even if others are provided with access to the main client. Thus, a need exists for an improved method and system for securing electronic mail folders in order to thereby prevent a security breach.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole.

It is, therefore, one aspect of the present invention to provide for an improved data-processing method, system and computer-usable medium.

It is a further aspect of the present invention to provide for an improved method, system and computer-usable medium for securing e-mail system by locking electronic folders.

The aforementioned aspects and other objectives and advantages can now be achieved as described herein. A system and method for securing electronic mail by providing secure access to electronic mail folders is disclosed. A number of folders can be created in order to classify electronic mail content and selected folders can be encrypted and locked utilizing a password. A closed lock appears by the side of the folder when the folder is locked and an open lock appears when the folder is opened providing visual indication thereto. The folders can also be automatically locked after a period of pause, which can be defined, by a user or the electronic mail system. The electronic mail content in the locked folders cannot be displayed when a user selects to display the contents of all folders in order to provide additional level of security. Similarly, restricted access can also be provided to a user or a group of users to access the locked folder. The access to the locked folders can be restricted to “read only”, “read and write” and so on.

The e-mail system displays information from the folders that are open and from the general folders that are not locked when a user selects to display the contents of all folders. The mails stored within the locked folders may not be visible even if the e-mail system is hacked. The mails from particular users can also be routed to the locked folders. The new e-mail sent to the locked folders can be highlighted if the e-mail is unread in order to provide visual indication thereto. The user can choose to protect or unprotect the created folder at any time in real time applications. Such an approach provides a robust solution for securing e-mail client systems by locking folders.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a computer system in which the present invention may be embodied;

FIG. 2 illustrates a schematic view of a software system including an operating system, application software, and a user interface for carrying out the present invention;

FIG. 3 illustrates a graphical representation of a network of data processing systems in which aspects of the present invention may be implemented;

FIG. 4 illustrates a graphical user interface window of a prior art e-mail system;

FIG. 5 illustrates a graphical user interface window of a secured e-mail system, which can be implemented in accordance with a preferred embodiment;

FIG. 6 illustrates a flow chart of operations illustrating a method for locking folders of the e-mail system, which can be implemented in accordance with a preferred embodiment;

FIG. 7 illustrates a flow chart of operations illustrating a method for accessing locked folders of the e-mail system, which can be implemented in accordance with a preferred embodiment;

FIG. 8 illustrates a flow chart of operations illustrating a method for accessing locked folders of the e-mail system, which can be implemented in accordance with a preferred embodiment; and

FIG. 9 illustrates a flow chart of operations illustrating a method for providing locked folders access to another user e-mail, which can be implemented in accordance with the preferred embodiment.

### DETAILED DESCRIPTION

The particular values and configurations discussed in these non-limiting examples can be varied and are cited merely to illustrate at least one embodiment and are not intended to limit the scope of such embodiments.

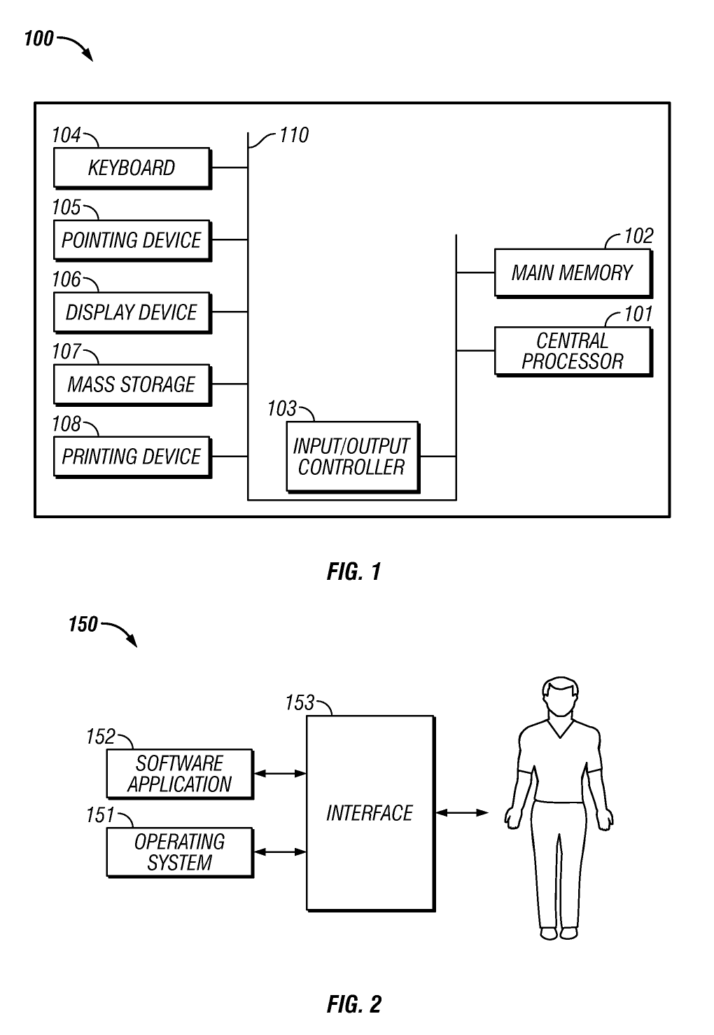

FIGS. 1-3 are provided as exemplary diagrams of data processing environments in which embodiments of the present invention may be implemented. It should be appreciated that FIGS. 1-3 are only exemplary and are not intended to assert or imply any limitation with regard to the environments in which aspects or embodiments of the present invention may be implemented. Many modifications to the depicted environments may be made without departing from the spirit and scope of the present invention.

FIG. 1 illustrates that the present invention may be embodied in the context of a data-processing system 100 comprising a central processor 101, a main memory 102, an input/output controller 103, a keyboard 104, a pointing device 105 (e.g., mouse, track ball, pen device, or the like), a display device 106, and a mass storage 107 (e.g., hard disk). Additional input/output devices, such as a printing device 108, may be included in the data-processing apparatus 100 as desired. As illustrated, the various components of the data-processing system 100 communicate through a system bus 110 or similar architecture.

Illustrated in FIG. 2, a computer software system 150 is provided for directing the operation of the data-processing apparatus 100. Software system 150, which is stored in system memory 102 and on disk memory 107, includes a kernel or operating system 151 and a shell or interface 153. One or more application programs, such as application software 152, may be “loaded” (i.e., transferred from storage 107 into memory 102) for execution by the data-processing apparatus 100. The data-processing system 100 receives user commands and data through user interface 153; these inputs may then be acted upon by the data-processing apparatus 100 in accordance with instructions from operating module 151 and/or application module 152.

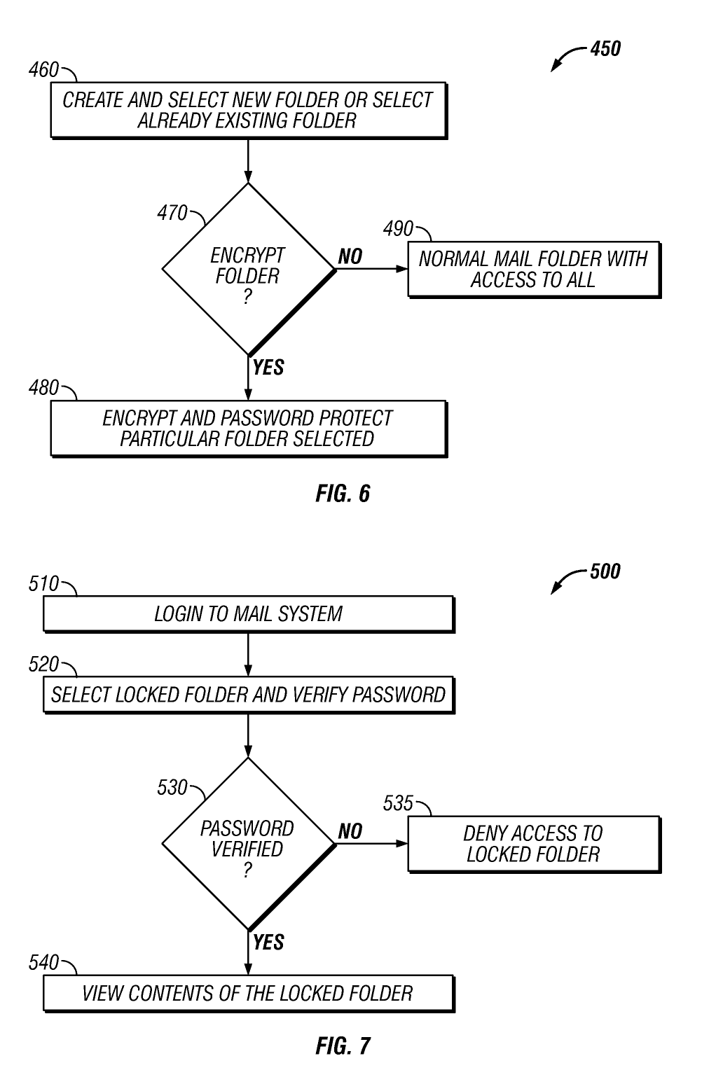

The interface 153, which is preferably a graphical user interface (GUI), also serves to display results, whereupon the user may supply additional inputs or terminate the session. In an embodiment, operating system 151 and interface 153 can be implemented in the context of a “Windows” system. Application module 152, on the other hand, can include instructions, such as the various operations described herein with respect to the various components and modules described herein, such as, for example, the method 450 depicted in FIG. 6 and the method 600 depicted in FIG. 9.

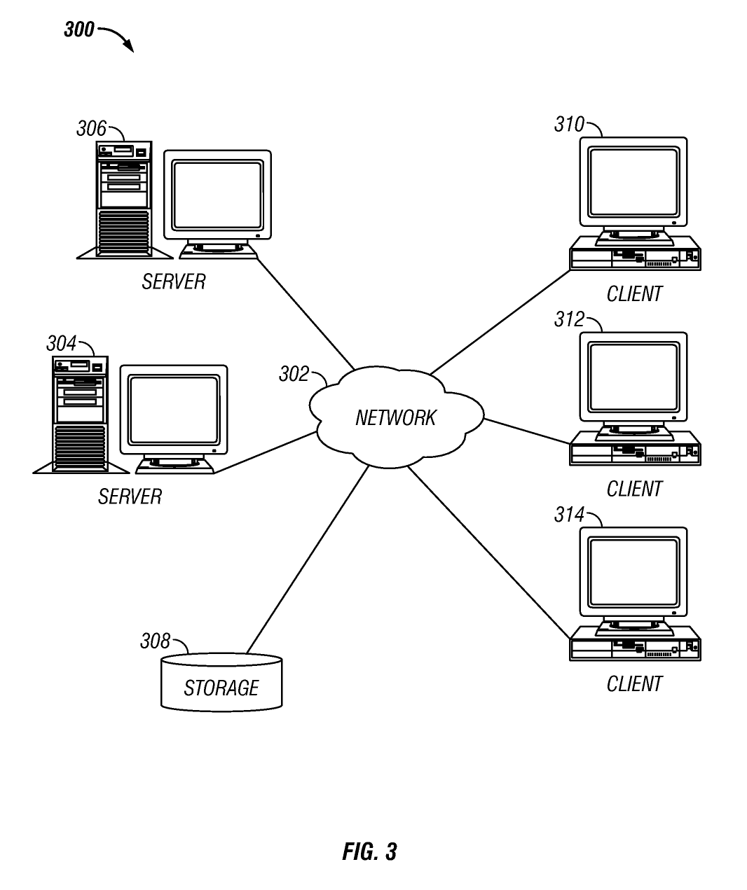

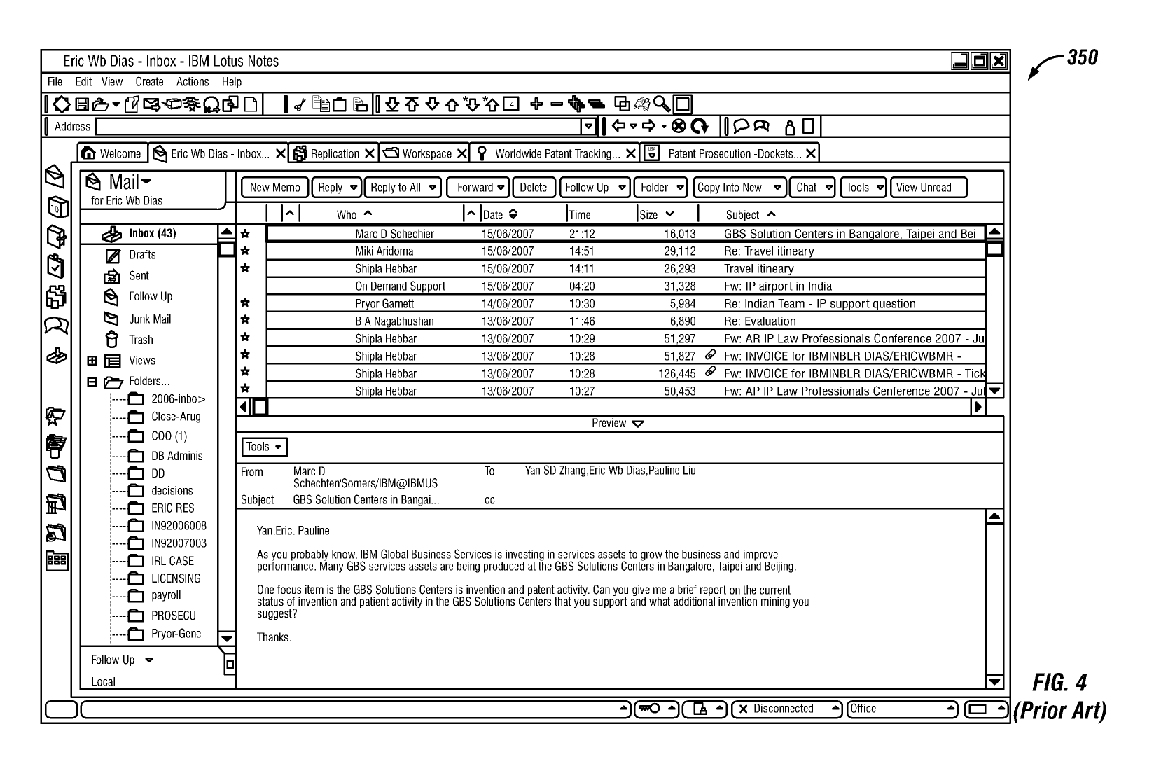

FIG. 3 illustrates a graphical representation of a network of data processing systems in which aspects of the present invention may be implemented. Network data processing system 300 is a network of computers in which embodiments of the present invention may be implemented. Network data processing system 300 contains network 302, which is the medium used to provide communications links between various devices and computers connected together within network data processing apparatus 100. Network 102 may include connections, such as wire, wireless communication links, or fiber optic cables.

In the depicted example, server 304 and server 306 connect to network 302 along with storage unit 308. In addition, clients 310, 312, and 314 connect to network 302. These clients 310, 312, and 314 may be, for example, personal computers or network computers. Data-processing system 100, as depicted in FIG. 1, can be, for example, a client such as client 310, 312, and/or 314. Alternatively, data-processing system 100 can be implemented as a server, such as servers 304 and/or 306, depending upon design considerations.

In the depicted example, server 304 provides data, such as boot files, operating system images, and applications to clients 310, 312, and 314. Clients 310, 312, and 314 are clients to server 304 in this example. Network data processing system 300 may include additional servers, clients, and other devices not shown. Specifically, clients may connect to any member of a network of servers which provide equivalent content.

In the depicted example, network data processing system 300 is the Internet with network 302 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 300 also may be implemented as a number of different types of networks, such as for example, an intranet, a local area network (LAN), or a wide area network (WAN). FIG. 1 is intended as an example and not as an architectural limitation for different embodiments of the present invention.

The following description is presented with respect to embodiments of the present invention, which can be embodied in the context of a data-processing system such as data-processing system 100, computer software system 150 and data processing system 300 and network 302, depicted respectively in FIGS. 1-3. The present invention, however, is not limited to any particular application or any particular environment. Instead, those skilled in the art will find that the system and methods of the present invention may be advantageously applied to a variety of system and application software, including database management systems, word processors, and the like. Moreover, the present invention may be embodied on a variety of different platforms, including Macintosh, UNIX, LINUX, and the like. Therefore, the description of the exemplary embodiments, which follows, is for purposes of illustration and not considered a limitation.

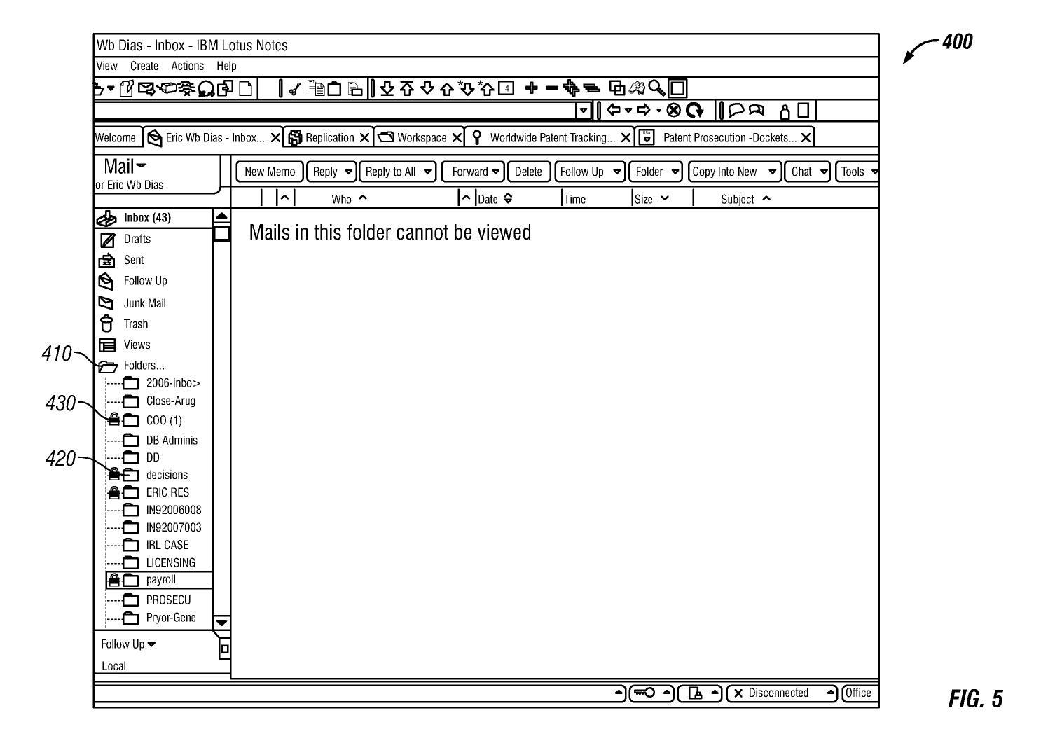

FIG. 5 illustrates a GUI window of a secured e-mail system 500, which can be implemented in accordance with a preferred embodiment. Note that GUI window of the secured e-mail system 400 can be implemented utilizing a GUI, such as the GUI 153 as depicted in FIG. 2, and can be provided by a module, such as, for example, software application module 152. GUI window 400 can be displayed via a display device such as display device 106, as depicted in FIG. 1, and implemented via the GUI 153. The email system 400 includes the ability to send and receive e-mail from anywhere utilizing a single application such as a web browser. The GUI window of the secured e-mail system 400 generally includes a number of folders 410, as shown in FIG. 5, which can be utilized to classify the electronic mail content.

The folders 410 allow a user of the electronic mail system 400 to store related electronic mail messages in the same folder in a way that is very similar to how directories allow a user of a file system to store related files in the same directory. The folders 420 can also be encrypted and locked by means of a password. A lock 420 appears by the side of the folder 420 when the folder 420 is locked and an open lock (not shown) appears when the folder 420 is opened providing visual indication that the folder 420 is open. The folder 420 can also be automatically locked after a period of pause, which can be defined by a user or the e-mail system 400.

When the e-mail system 400 receives an e-mail message for a user, the e-mail system 400 stores the electronic mail message to the corresponding folders within the user's electronic mail. The contents in the locked folder 420 cannot be displayed when the user selects to display the contents of all folders. The e-mail system 400 displays information from the folder that is open and general folders that are not locked in order to provide additional level of security. The mails from particular users can also be routed to the locked folders 420. Similarly, restricted access can be provided to a user or a group of users to access the locked folder 420. For example, consider that users “X”, “Y” and “Z” can be provided restricted access to the locked folder 420 in users “A” email. The user “A” can select the folder 420 and provide only access to users “X”, “Y” and “Z”. The access to users “X”, “Y” and “Z” can be restricted to “read only”, “read and write” and so on. However, other users cannot be provided access to delete any mails from users “A” account in the folder that can be accessed by users “X”, “Y” and “Z”.

FIG. 6 illustrates a flow chart of operations illustrating a method 450 for locking folders of the e-mail system 400, which can be implemented in accordance with a preferred embodiment. Note that the method 450 can be implemented in the context of a computer-useable medium that contains a program product. A new folder, such as a folder 420, can be created and selected or an existing folder can be selected, as illustrated at block 460. A determination can be made whether a restricted access is required for the selected folders, as illustrated at block 470. If restricted access is required, the particular selected folders can be encrypted and password protected, as depicted at block 480. The electronic mail content moved to the encrypted folders can also be protected and access to other users can be restricted. Otherwise, the folders can be remained as normal folders with access to all users, as depicted at block 490.

FIG. 7 illustrates a flow chart of operations illustrating a method 500 for accessing locked folders of the e-mail system 400, in accordance with the preferred embodiment. A user can login to the e-mail client system 400, as illustrated at block 510. The locked folders such as folder 420 can be displayed with a lock 430 by the side of the folder 420. The locked folders can be selected and the password can be verified, as illustrated at block 520. A determination can be made whether the user enters the correct password, as depicted at block 530. If the access password matches, the contents of the locked folders can be provided to the user, as illustrated at block 540. Otherwise, access can be denied to the locked folder, as depicted at block 535.

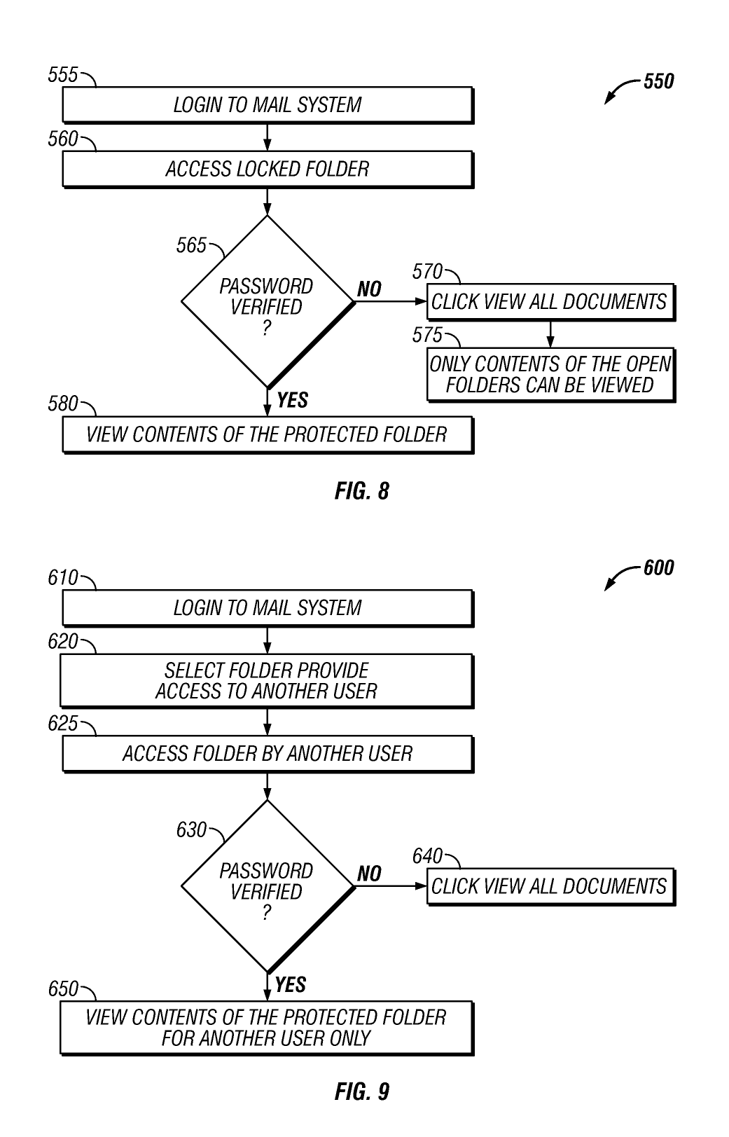

FIG. 8 illustrates a flow chart of operations illustrating a method 550 for accessing locked folders of the e-mail system 400, in accordance with the preferred embodiment. A user can login to the mail system, as illustrated at block 555. The locked folders of the e-mail client system 400 can be accessed by providing the right password, as illustrated at block 560 and 565. If the password matches, the user can view the contents of the locked folder, as illustrated at block 580. Otherwise, “view all documents” option can be clicked by the user, as illustrated at block 570. The contents of the folder that are open and general folders that are not locked can be displayed and viewed by the user, as illustrated at block 575.

FIG. 9 illustrates a flow chart of operations illustrating a method 600 for providing locked folder access to another user of the e-mail system 400, in accordance with the preferred embodiment. Note that the method 500, 550 and 600 can be implemented in the context of a computer-useable medium that contains a program product. A user can login to the e-mail system, as illustrated at block 610. A folder can be selected to provide access to another user, as illustrated at block 620. The access password of another user can be verified, as illustrated at blocks 625 and 630. If the password matches, then another user can view the contents of the locked folders, as depicted at block 650.

Otherwise, another user can “click” to view all document options in order to view unlocked and general folders, as illustrated at block 640. The e-mail messages stored within the locked folders 420 may not be visible even if the e-mail system is hacked, which provides an additional level of security to the e-mail system 400. Access to the locked folders 420 can be restricted to “read only”, “read and write” and so on. The new e-mail message sent to the locked folders 420 can also be highlighted if the e-mail message has not been read. The user can choose to protect or unprotect the created folder at any time in real time applications. Such an approach provides a robust solution for securing e-mail client systems by locking folders thereby preventing a security breach.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A computer-implemented method for securing electronic mail, said computer-implemented method comprising:
encrypting and locking at least one folder associated with an electronic mail system utilizing a password provided by a user, in order to form at least one locked folder thereof, wherein said at least one locked folder provides a secure access to electronic mail content associated with said at least one locked folder.

2. The computer-implemented method of claim 1, further comprising:
displaying for said user, a graphical symbol with respect to said at least one locked folder wherein said graphical symbol indicates to said user whether said at least one locked folder is locked or unlocked, thereby providing a visual indication thereto regarding a status of said at least one locked folder.

3. The computer-implemented method of claim 1, further comprising:
automatically locking said at least one locked folder after a pre-defined period of pause in order to provide said secure access to said at least one locked folder thereby preventing a security breach with respect to said electronic mail content, wherein said pre-defined period is defined by said user.

4. The computer-implemented method of claim 1, further comprising:
routing electronic mail from at least one user to said at least one locked folder in order to provide an additional level of security.

5. The computer-implemented method of claim 4, further comprising:
highlighting said at least one locked folder, if said at least one locked folder possesses an unread email message therein, in order to provide a visual indication thereto.

6. The computer-implemented method of claim 1, further comprising:
providing a restricted access to said user with respect to said at least one locked folder utilizing said password.

7. The computer-implemented method of claim 1, further comprising:
providing a restricted access to a group of users with respect to said at least one locked folder utilizing said password.

8. The computer-implemented method of claim 7, wherein said password is capable of being different with respect to said group of users.

9. The computer-implemented method of claim 8, wherein said password is capable of being different with respect to each user within said group of users.

10. The computer-implemented method of claim 6, further comprising:
automatically restricting said user to a read only level of security with respect to said at least one locked folder and said electronic mail content contained therein, in response to a particular user input.

11. The computer-implemented method of claim 6, further comprising:
automatically restricting said group of users to a read only level of security with respect to said at least one locked folder and said electronic mail content contained therein, in response to a particular user input.

12. The computer-implemented method of claim 1, further comprising:
denying a display of said electronic mail content associated with said at least one locked folder, if said user requests a display of electronic mail content of said electronic mail system.

13. A system for securing electronic mail, said system comprising:
a data bus coupled to said processor; and
a computer-usable medium embodying computer code, said computer-usable medium being coupled to said data bus, said computer program code comprising instructions executable by said processor and configured for:
encrypting and locking at least one folder associated with an electronic mail system utilizing a password provided by a user in order to form at least one locked folder thereof, wherein said at least one locked folder provides a secure access to electronic mail content associated with said at least one locked folder.

14. The system of claim 13, wherein said instructions are further configured for:
displaying for said user a graphical symbol with respect to said at least one locked folder, wherein said graphical symbol indicates to said user whether said at least one locked folder is locked or unlocked, thereby providing a visual indication thereto regarding a status of said at least one locked folder; and
automatically locking said at least one locked folder after a pre-defined period of pause in order to provide said secure access to said at least one locked folder thereby preventing a security breach with respect to said electronic mail content, wherein said pre-defined period is defined by said user.

15. The system of claim 13, wherein said instructions are further configured for:
routing electronic mail from at least one user to said at least one locked folder in order to provide an additional level of security; and
highlighting said at least one locked folder, if said at least one locked folder possesses an unread email message therein, in order to provide a visual indication thereto.

16. A computer-usable medium for securing electronic mail, said computer-usable medium embodying computer program code, said computer program code comprising computer executable instructions configured for:
encrypting and locking at least one folder associated with an electronic mail system utilizing a password provided by a user, in order to form at least one locked folder thereof, wherein said at least one locked folder provides a secure access to electronic mail content associated with said at least one locked folder.

17. The computer-usable medium of claim 16, wherein said embodied computer program code further comprises computer executable instructions configured for:
displaying for said user a graphical symbol with respect to said at least one locked folder, wherein said graphical symbol indicates to said user whether said at least one locked folder is locked or unlocked, thereby providing a visual indication thereto regarding a status of said at least one locked folder;
automatically locking said at least one locked folder after a pre-defined period of pause in order to provide said secure access to said at least one locked folder thereby preventing a security breach with respect to said electronic mail content, wherein said pre-defined period is defined by said user; and
routing electronic mail from at least one user to said at least one locked folder in order to provide an additional level of security.

18. The computer-usable medium of claim 16, wherein said embodied computer program code further comprises computer executable instructions configured for:
highlighting said at least one locked folder, if said at least one locked folder possesses an unread email message therein, in order to provide a visual indication thereto.

19. The computer-usable medium of claim 16, wherein said embodied computer program code further comprises computer executable instructions configured for:
providing a restricted access to said user with respect to said at least one locked folder utilizing said password.

20. The computer-usable medium of claim 16, wherein said embodied computer program code further comprises computer executable instructions configured for:
routing electronic mail from at least one user to said at least one locked folder in order to provide an additional level of security; and
highlighting said at least one locked folder, if said at least one locked folder possesses an unread email message therein, in order to provide a visual indication thereto.
